(19) United States
(12) Patent Application Publication
(10) Pub. No.: US 2015/0304829 A1
(43) Pub. Date: Oct. 22, 2015

(54) CALL FORWARDING VERIFICATION

(71) Applicant: VONAGE NETWORK, LLC, HOLMDEL, NJ (US)

(72) Inventors: BOAZ ZEHAVI, JERSEY CITY, NJ (US); JAYA MEGHANI, OLD BRIDGE, NJ (US); KAI XIN, EAST BRUNSWICK, NJ (US)

(73) Assignee: VONAGE NETWORK, LLC, HOLMDEL, NJ (US)

(21) Appl. No.: 14/258,438

(22) Filed: Apr. 22, 2014

(51) Int. Cl. H04W 4/16; H04W 24/04; H04M 3/24; H04M 7/00; H04M 3/58; H04W 24/08

(52) U.S. Cl. CPC H04W 4/16; H04M 3/58; H04W 24/08; H04M 3/244; H04M 7/0057; H04W 24/04

(57) ABSTRACT

A telephony system (20) comprises a computer-implemented call forwarding verification system (60) configured to initiate a test call to a telephony device (30) in conjunction with a request for a call forwarding operation. The request for the call forwarding operation is configured to instruct that a subsequent call to the telephony device be directed to a forwarding number. Preferably the forwarding number is a number associated with the telephony system (20).

### TECHNICAL FIELD

The technology relates to telecommunications, and particular to Internet Protocol (IP) telephone systems that are accessible to mobile telephony devices.

### BACKGROUND

A telephone subscriber generally has one or more telephony devices which are served by a home carrier and which are associated with a nominal telephone number, such as a directory number. The directory number generally corresponds to an account for the subscriber. Telephonic communications emanating or originating from a telephony device of the subscriber as a calling party (e.g., outgoing communications) are generally routed by the calling party's home carrier through one or more switches, and possibly networks of other carriers, to a called party. The called party may be a subscriber of the same or of another home carrier. Conversely, telephonic communications destined for the telephony device of the called telephone subscriber (e.g., incoming communications) are routed on the basis of, e.g., the nominal telephone number, through switches to the called party's home carrier so that the communications may be “terminated” at the called party, i.e., the telephone subscriber.

In some instances in which the telephone device is an analogue device, the communications involving the telephone subscriber may be initiated as analogue communications and thereafter may be adapted for packet transmission. In other cases the telephony device may be a data packet-compatible device, such as an Internet Protocol (IP) device, so that the communication is essentially entirely packet-based. In either case, Internet Protocol telephony systems have been provided to route various types of communications, at least in part, via data packets that are communicated over a data network. The data network is commonly the Internet. The types of communications may be, for example, telephone calls, video calls, text and video messages, and other forms of telephony and data communications.

In some instances an outgoing communication may be routed at the subscriber's request to the Internet Protocol telephony system, so that the communications may be completed or “terminated” by the Internet Protocol telephony system. Conversely, many telephone providers provide a service such as “call forwarding” wherein an incoming communication to the nominal telephone number of the subscriber may be directed, at least temporarily, to another number where the subscriber would prefer to take the call. In this way using the “call forwarding” feature an incoming communication may be routed to another number which is associated with the Internet Protocol telephony system so that the incoming communication may be routed at least in part through the Internet Protocol telephony system en route to the subscriber.

Some users or subscribers of the IP telephony system may engage in communications using telephony devices that are connected by physical lines such as cables or wires to an access point such as an internet port. Such wired telephony devices may, thanks to the services of the IP telephony system, be moved from one physical location to another physical location, but at each such physical location are physically connected in wired manner to the respective access point.

Other users or subscribers of the IP telephony system may possess mobile or wireless telephony devices, such as a wireless terminal, user equipment (UE), mobile phone, smart phone, or laptop, tablet, or other device with mobile termination. When such a mobile telephony device is within coverage of an appropriate wireless access network (e.g., WiFi or WiMAX network) that has connection to the a data network such as the Internet, the communications involving the mobile telephony device may be handled by the IP telephony system in conjunction with the wireless access network. In other words, the communications may occur wirelessly between the mobile telephony device and a wireless access point of the wireless access network, with the wireless access point in turn being connected to an Internet portal. Typically the wireless connection of the mobile telephony device to the wireless access point is over unlicensed radio frequency resource(s). Access in this manner to the Internet portal enables the mobile telephony device to capitalize upon the service of the IP telephony system in economically routing the communications through the Internet, rather than over existing non-Internet service carriers, e.g., over a mobile radio access network.

When a mobile telephony device is not in range of a wireless access network and accordingly not able to gain the benefit of the IP telephony service, the mobile telephony device may instead be served by other carriers/services using one or more mobile radio access networks. Such mobile radio access networks typically comprise plural base stations which have both radio frequency transmitting and receiving capabilities to serve macro cells and typically use licensed frequency resource(s), such as GSM type mobile networks. A macro cell is essentially defined by the extent of the transmitting and receiving capabilities of the base station. The mobile telephony devices located within the cell may communicate with the radio access network through the base station (unless the customer also happens to be within range of another wireless network, such as a WiFi wireless network or the like, and exercises the option to use the other wireless network instead of the radio access network). In some instances such a “macro” base station may be called a “radio base station”, “base station”, NodeB, eNodeB, or the like.

A subscriber of a IP telephony service having a mobile telephony device, e.g., a wireless terminal, may wish that an incoming communication to the mobile telephony device be carried by the IP telephony service rather than through a radio access network which uses licensed frequencies. Indeed there are often economic motivations or incentives for use of the IP telephony service, particularly in countries or situations when a called mobile party bears the cost for a call routed through the radio access network. In such situations the subscriber of a IP telephony service having a mobile telephony device may place a call forwarding request, e.g., to request the home carrier to forward an incoming communication to the subscriber's nominal telephone number to an alternate number, such as a telephone number of a server of the IP telephony service. Such incoming communications which are forwarded or redirected to the server of the IP telephony service enable the IP telephony service to route the call through the data network (e.g., Internet) to the wireless access point that currently serves the subscriber's mobile telephony device. An example of call forwarding in conjunction with a IP telephony system is described in U.S. Pat. No. 8,600,364, which is incorporated herein by reference.

Although the subscriber may request a call forwarding operation, either by direct request or indirect request to the home network, the call forwarding request may not be immediately implemented, or may not be implemented at all. Typically knowledge regarding the call forwarding operation is in possession of the mobile home operator, and may be difficult for an IP telephony system to obtain. Since the economic repercussions of implementation or failure of the call forwarding request may be significant, notification (e.g., to IP telephony system and to the wireless telephony device) of the fate of the call forwarding request may be beneficial in many cases. Such notification could be helpful, for example, to the IP telephony system in terms of billing, metrics, and troubleshooting.

### SUMMARY

In one of its aspects the technology disclosed herein concerns a telephony system comprising a computer-implemented call forwarding verification system. The call forwarding verification system is configured to initiate a test call to a telephony device in conjunction with a request for a call forwarding operation. The request for the call forwarding operation is configured to instruct that a subsequent call to the telephony device be directed to a forwarding number.

In an example embodiment and mode the test call is based on an identifier associated with telephony device.

In an example embodiment and mode the forwarding verification system is configured to monitor for receipt of an indication that the test call was successfully directed to the forwarding number.

In an example embodiment and mode the computer-implemented call forwarding verification system is configured to receive from the telephony device a notification that the call forwarding operation is being requested.

In an example embodiment and mode the computer-implemented call forwarding verification system is configured to request the telephony device to request that a native home carrier implement the call forwarding operation, and the computer-implemented call forwarding verification system is configured to thereafter make the test call.

In an example embodiment and mode the notification that the call forwarding operation comprises a message from the telephony device configured to request the call forwarding operation.

In an example embodiment and mode the forwarding number is associated with the call forwarding verification system, and the computer-implemented call forwarding verification system is further configured to store a tracking indication of initiation of the test call to the telephony device in a record pertaining to the telephony device in a verification system database; and, upon receipt by the verification system of the test call, to determine a match between reception of the test call and the tracking indication stored in the verification system database.

In an example embodiment and mode the computer-implemented call forwarding verification system is configured to associate the test call with an identifier associated with a call forwarding attempt.

In an example embodiment and mode the computer-implemented call forwarding verification system is configured, upon receipt of an indication that the test call was successfully directed to the forwarding number, to generate a transmission to the telephony device confirming implementation of the call forwarding operation.

In another of its aspects the technology disclosed herein concerns a telephony device comprising a processor. The processor is configured, in conjunction with a request for a call forwarding operation, to send, to an Internet telephony service, a notification that the call forwarding operation is being requested. The request for the call forwarding operation is configured to instruct that a subsequent call to the telephony device be directed to a forwarding number. The processor is also configured, when the call forwarding operation has failed, to decline a test call that is received, the test call having originated from the Internet telephony service as a result of the notification.

In an example embodiment and mode the telephony device is a wireless telephony device comprising a transceiver configured to participate in wireless communications. In an example implementation the processor is further configured to send the request for the call forwarding operation upon detection of service of the wireless access network.

In an example embodiment and mode the processor is further configured to send an identifier associated with the telephony device, and the test call is based on the identifier.

In an example embodiment and mode the processor is further configured to send a failure notification to the Internet telephony service upon receipt by the telephony device of the test call.

In an example embodiment and mode the processor is further configured, when the call forwarding operation has failed, to decide how to handle a call received through the radio access network other than the test call.

In an example embodiment and mode the processor is further configured, when the call forwarding operation has been implemented, to receive a confirmatory indication from the Internet telephony service.

In an example embodiment and mode the processor is further configured to send, as the notification to the Internet telephony network, a request for the call forwarding operation.

In an example embodiment and mode the processor is configured to include, in the notification, information that prompts the Internet telephony service to perform a call forwarding verification operation.

In an example embodiment and mode the processor is configured to include, in the notification, information that enables the Internet telephony service to perform a call forwarding verification operation.

In an example embodiment and mode the information comprises at least one or more of a nominal telephone number associated with the telephony device, an identifier associated with the telephony device, or an account associated with the telephony device.

In an example embodiment and mode the test call is originated from the Internet telephony service and bears an identifier associated with a call forwarding attempt.

In another of its aspects the technology disclosed herein concerns a computer program product. The computer program product is stored on a non-transient, computer-readable storage medium and comprises coded instructions which, when executed by a processor, cause the processor to perform certain acts. The acts performed upon execution of the computer program product instructions include sending, to an Internet telephony service, a notification that the call forwarding operation is being requested (the request for the call forwarding operation being configured to instruct that a subsequent call to a telephony device be directed to a forwarding number) and thereafter, when the call forwarding operation has failed, declining a test call that is received (the test call originating from the Internet telephony service as a result of the notification).

In an example embodiment and mode execution of the coded instructions by the processor causes performance of the further act of sending an identifier associated with telephony device, the test call being based on the identifier.

In an example embodiment and mode execution of the coded instructions by the processor causes performance of the further act of sending a failure notification to the Internet telephony service upon receipt by the telephony device of the test call.

In an example embodiment and mode execution of the coded instructions by the processor causes performance of the further act of, when the call forwarding operation has failed, deciding how to handle a call received other than the test call.

In an example embodiment and mode execution of the coded instructions by the processor causes performance of the further act of, when the call forwarding operation has been implemented, receiving a confirmatory indication from the Internet telephony service.

In an example embodiment and mode wherein execution of the coded instructions by the processor causes performance of the further act of sending, as the notification to the Internet telephony network, a request for the call forwarding operation.

In an example embodiment and mode execution of the coded instructions by the processor causes performance of the further act of sending the request for the call forwarding operation upon detection of service of a wireless access network.

In an example embodiment and mode execution of the coded instructions by the processor causes performance of the further act of sending a request for the call forwarding operation to a home carrier associated with the telephony device.

In an example embodiment and mode execution of the coded instructions by the processor causes performance of the further act of including, in the notification, information that prompts the Internet telephony service to perform a call forwarding verification operation.

In an example embodiment and mode execution of the coded instructions by the processor causes performance of the further act of including, in the notification, information that enables the Internet telephony service to perform a call forwarding verification operation.

In an example embodiment and mode the information comprises at least one of a nominal number of the telephony device, an identifier associated with the telephony device, and an account associated with the telephony device.

In another of its aspects the technology disclosed herein concerns a method in a communications network. In a basic embodiment and mode the method comprises (1) an Internet telephony service initiating a test call based on an identifier associated with a telephony device in conjunction with a request for a call forwarding operation (the request for the call forwarding operation being configured to instruct that a subsequent call to the telephony device be directed to a forwarding number); (2) the Internet telephony service monitoring for receipt of an indication that the test call was successfully directed to the forwarding number.

In an example embodiment and mode the test call is based on an identifier associated with telephony device, and the identifier comprises a nominal telephone number or indicates a nominal telephone number.

In an example embodiment and mode the Internet telephony service, upon receipt of an indication that the test call was successfully directed to the forwarding number, generates a transmission to the telephony device confirming implementation of the call forwarding operation.

In an example embodiment and mode the Internet telephony service requests the telephony device to request that a native home carrier implement the call forwarding operation, and thereafter the Internet telephony service makes the test call.

In an example embodiment and mode the Internet telephony service stores a tracking indication of initiation of the test call to the telephony device in a record pertaining to the telephony device in a verification system database; and upon receipt by the verification system of the test call from the mobile carrier network, determines a match between reception of the test call and the tracking indication stored in the verification system database.

In an example embodiment and mode the Internet telephony service upon determining the match, generates the transmission to the telephony device confirming the implementation of the call forwarding operation.

In an example embodiment and mode when the call forwarding operation has failed, the telephony device receives the test call through the radio access network and declines the test call.

In an example embodiment and mode further comprising the telephony device sends a failure notification to the Internet telephony service upon receipt of the test call.

In an example embodiment and mode the telephony device sends a failure notification to the Internet telephony service when the call forwarding operation has failed.

In an example embodiment and mode the telephony device decides how to handle a call received other than the test call when the call forwarding operation has failed.

In an example embodiment and mode, when the call forwarding operation has been implemented, the telephony device receives a confirmatory indication from the Internet telephony service.

In an example embodiment and mode the telephony device sends, as the notification to the Internet telephony network, a request for the call forwarding operation.

In an example embodiment and mode the telephony device sends the request for the call forwarding operation upon detection of service of the access network.

In an example embodiment and mode the telephony device sends a request for the call forwarding operation through a radio access network to a home carrier associated with the telephony device.

In an example embodiment and mode the telephony device includes, in the notification, information that prompts the Internet telephony service to perform a call forwarding verification operation.

In an example embodiment and mode the telephony device includes, in the notification, information that enables the Internet telephony service to perform a call forwarding verification operation.

In an example embodiment and mode the information comprises at least one or more of a nominal telephone number associated with the telephony device, an identifier associated with the telephony device, and an account associated with the telephony device.

### BRIEF DESCRIPTION OF THE DRAWINGS

The foregoing and other objects, features, and advantages of the technology disclosed herein will be apparent from the following more particular description of preferred embodiments as illustrated in the accompanying drawings in which reference characters refer to the same parts throughout the various views. The drawings are not necessarily to scale, emphasis instead being placed upon illustrating the principles of the technology disclosed herein.

FIG. 1 is a diagrammatic view of an exemplary communications network in which verification of a call forwarding operation may be performed.

FIG. 2A, FIG. 2B, and FIG. 2C are diagrammatic views depicting various exemplary scenarios for requesting or initiating a call forwarding operation.

FIG. 3 is a schematic view illustrating example functionalities and or units comprising a non-limiting exemplary embodiment of a call forwarding verification system.

FIG. 4 is a schematic view illustrating example functionalities and or units comprising a non-limiting exemplary embodiment of a wireless telephony device according to an exemplary embodiment.

FIG. 5 is a flowchart illustrating basic exemplary acts or steps comprising a call forwarding verification operation performed in accordance with an exemplary embodiment and mode.

FIG. 6A and FIG. 6B are diagrammatic views depicting various exemplary actions for a successful call forwarding request and a failed call forwarding request, respectively.

FIG. 7 is a flowchart illustrating basic more detailed exemplary acts or steps performed by a call forwarding verification system in an exemplary embodiment and mode.

FIG. 8 is a schematic view shows an example of machine hardware comprising one or more processors for implementing aspects of an IP telephony system and a wireless telephony device according to exemplary embodiments.

### DETAILED DESCRIPTION

In the following description, for purposes of explanation and not limitation, specific details are set forth such as particular architectures, interfaces, techniques, etc. in order to provide a thorough understanding of the technology disclosed herein. However, it will be apparent to those skilled in the art that the technology disclosed herein may be practiced in other embodiments that depart from these specific details. That is, those skilled in the art will be able to devise various arrangements which, although not explicitly described or shown herein, embody the principles of the technology disclosed herein and are included within its spirit and scope. In some instances, detailed descriptions of well-known devices, circuits, and methods are omitted so as not to obscure the description of the technology disclosed herein with unnecessary detail. All statements herein reciting principles, aspects, and embodiments of the technology disclosed herein, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that block diagrams herein can represent conceptual views of illustrative circuitry or other functional units embodying the principles of the technology. Similarly, it will be appreciated that any flow charts, state transition diagrams, pseudocode, and the like represent various processes which may be substantially represented in computer readable medium and so executed by a computer or processor, whether or not such computer or processor is explicitly shown.

In the following description, the terms “VoIP system,” “VoIP telephony system,” “IP system” and “IP telephony system” are all intended to refer to a system that connects callers and that delivers data, text and video communications using Internet protocol data communications.

The following description will refer to “telephony communications.” The term “telephony communications” is intended to encompass any type of communication that could pass back and forth between users of an IP telephony system. This includes audio and video telephone, text messages, video messages and any other form of telephony or data communication.

In the following description, references will be made to an “IP telephony device.” This term is used to refer to any type of device which is capable of interacting with an IP telephony system to complete an audio or video telephone call or to send and receive text messages, and other forms of communications. An IP telephony device could be an IP telephone, a computer running IP telephony software, a telephone adapter which is itself connected to a normal analog telephone, or some other type of device capable of communicating via data packets. An IP telephony device could also be a cellular telephone or a portable computing device that runs a software application that enables the device to act as an IP telephone. Thus, a single device might be capable of operating as both a cellular telephone and an IP telephone.

The following description will also refer to a mobile telephony device. The term “mobile telephony device” is intended to encompass multiple different types of devices. In some instances, a mobile telephony device could be a cellular telephone. In other instances, a mobile telephony device may be a mobile computing device that includes both cellular telephone capabilities and a wireless data transceiver that can establish a wireless data connection to a data network. Such a mobile computing device could run appropriate application software to conduct VoIP telephone calls via a wireless data connection. Thus, a mobile computing device, such as an Apple iPhone™, a RIM Blackberry or a comparable device running Google's Android operating system could be a mobile telephony device.

In still other instances, a mobile telephony device may be a device that is not traditionally used as a telephony device, but which includes a wireless data transceiver that can establish a wireless data connection to a data network. Examples of such devices include the Apple iPod Touch™ and the iPad™. Such a device may act as a mobile telephony device once it is configured with appropriate application software.

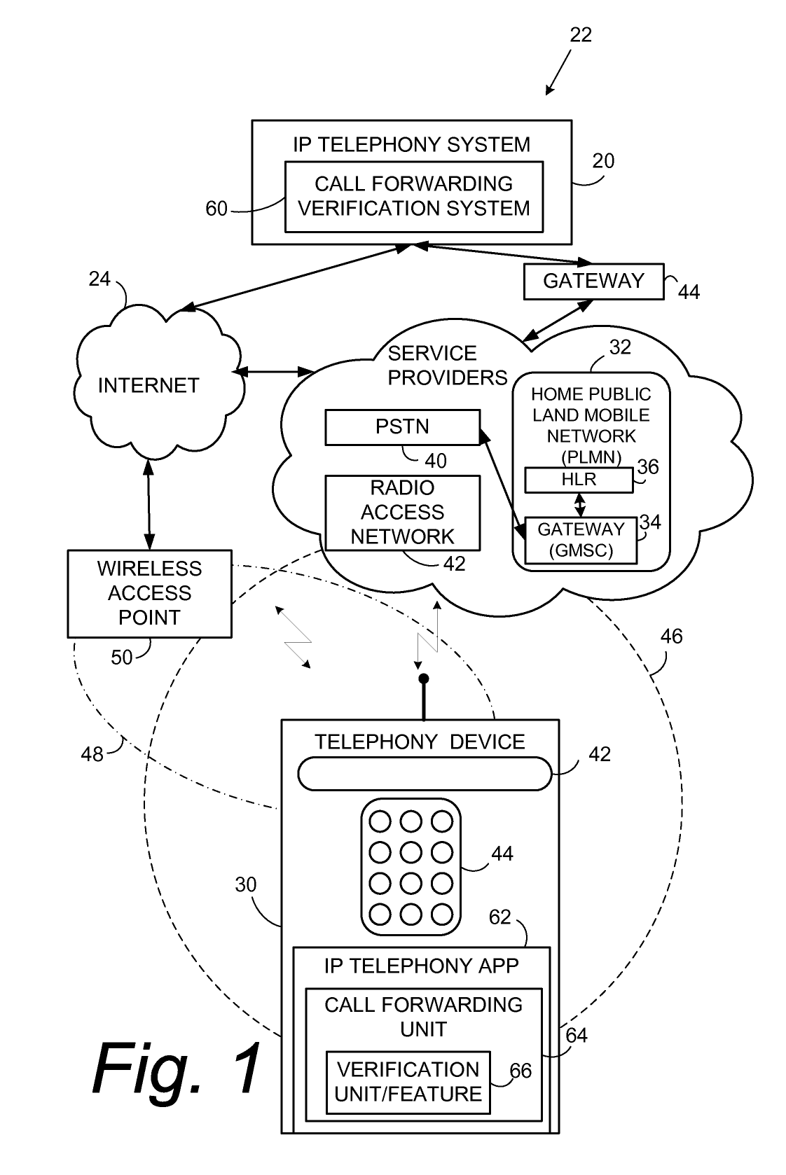

FIG. 1 shows an exemplary telephony system 20, in context of an exemplary generic communications system 22. In view of the fact that the telephony system 20 may be an Internet (IP) telephony service, the telephony system 20 is shown as connected to a data communications network such as Internet 24. A telephony device 30, which happens to be a mobile or wireless telephony device such as a user equipment unit, smart phone, or laptop with mobile termination, for example, is associated with a customer of the telephony system 20. For example, the wireless telephony device 30 may be used by an individual who has, or is a member of a group which has, an account or subscription with IP telephony system 20.

The customer is not only a customer of IP telephony system 20, but is also served by the customer's home public land mobile network 32, also known as the “home carrier”. The customer's home public land mobile network 32 is shown in FIG. 1 as comprising PLMN gateway or switching center (GMSC) 34, as well as a PLMN home location register (HLR) 36. The home public land mobile network 32 may be connected to or actually comprise the public switched telephone network (PSTN) 40. The home public land mobile network 32 is connected to public switched telephone network (PSTN) 40 through the PLMN gateway 34. The public switched telephone network (PSTN) 40 may be connected to or comprise one or more radio access network(s) (RANs) 42. The telephony system 20 is also connected to public switched telephone network (PSTN) 40 through one or more gateway(s) 44.

The radio access network(s) (RANs) 42 typically comprise one or more base stations which transmit and receive communications over radio frequencies for serving wireless terminals situated in macro cells defined by the respective coverage of the respective base stations. One such example, representative macro cell 46, is shown by dashed lines in FIG. 1 as covering, e.g., a location in which wireless telephony device resides, and thereby supplying radio access to wireless telephony device 30 as wireless telephony device 30 may request or require. Typically macro base stations of the radio access networks 42 communicate with mobile terminals in their respective macro cells 46 using licensed radio frequency resource(s). The radio access network(s) (RANs) 42 include those such as Global System for Mobile Communications (GSM), Universal Terrestrial Radio Access Network (UTRAN), and Long Term Evolution (LTE), or any other network technologies such as GSM/EDGE and UMTS/HSPA.

FIG. 1 also shows, by dashed-dotted line, a smaller cell 48 which is served by wireless access point 50. FIG. 1 shows wireless telephony device 30 as being within the smaller cell 48, which may be, e.g., a micro cell, pico cell, or femto cell. The wireless access point 50 may serve the wireless telephony device 30 using technologies such as Wi-Fi or WiMAX. Wi-Fi is a technology that allows an electronic device to exchange data or connect to the internet wirelessly using microwaves in the 2.4 GHz and 5 GHz bands, and thus includes any wireless local area network (WLAN) products that are based on the Institute of Electrical and Electronics Engineers' (IEEE) 802.11 standards. Typically such wireless access points 50 communicate with wireless devices within their cells 48 by using unlicensed radio frequency resource(s).

The technology disclosed herein concerns, e.g., methods, apparatus (either or both in a IP telephony system and in a wireless telephony device), and techniques for verification of implementation of a call forwarding operation. To that end, FIG. 1 shows IP telephony system 20 as comprising call forwarding verification system 60, and wireless telephony device 30 as comprising IP telephony application (app) 62. The IP telephony application 62 is typically provided by the IP telephony system 20. Some aspects of IP telephony application 62 may be described in U.S. Pat. No. 8,600,364, incorporated herein by reference. The IP telephony application 62 includes call forwarding unit 64, which executes a call forwarding application. Included in call forwarding unit 64 of wireless telephony device 30 is call forwarding verification unit 66.

The wireless telephony device 30 also comprises user input and output interfaces, such as input/output touchscreen/display screen 42 and keypad 44. It should be understood that other input and output devices are also included, such as microphone and speakers.

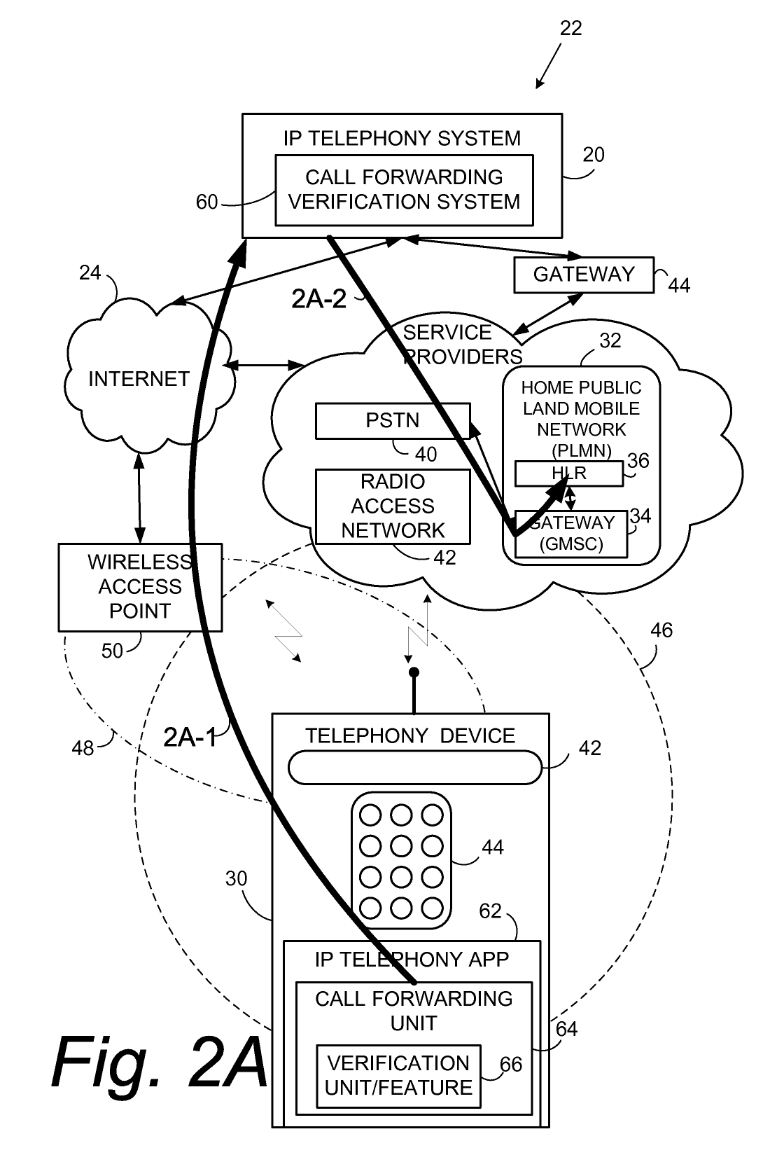

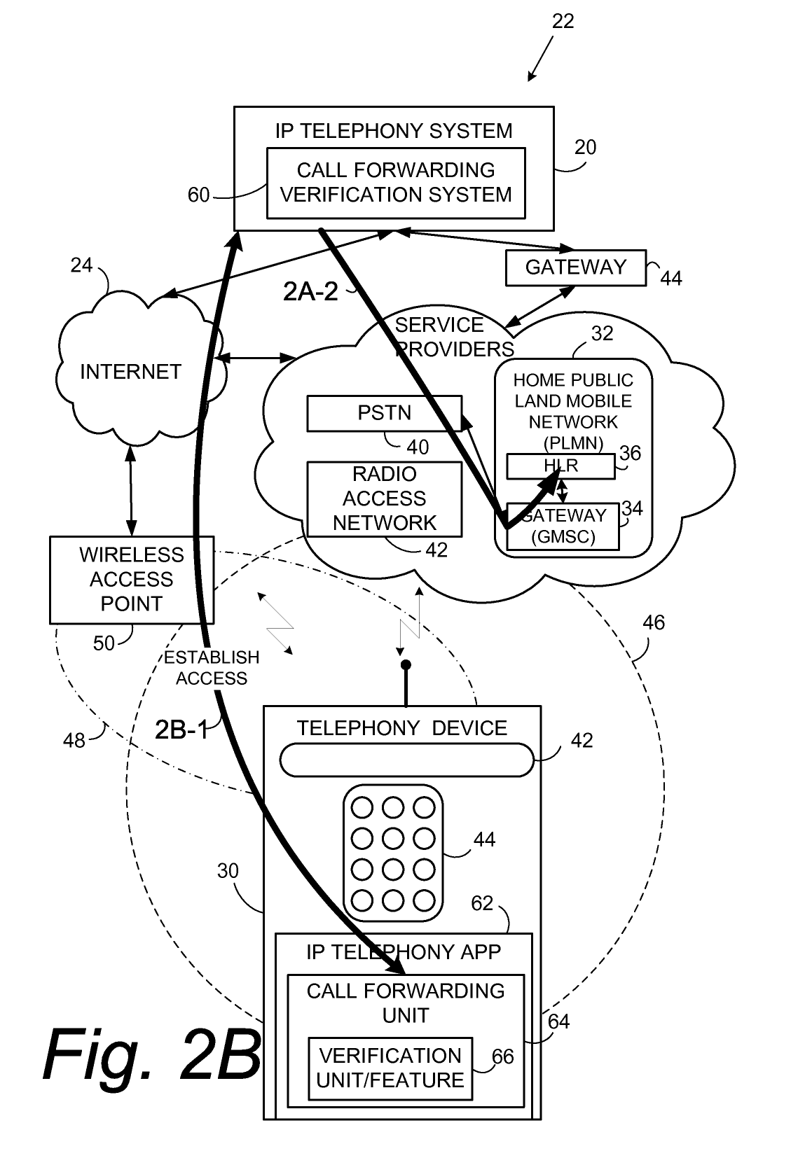

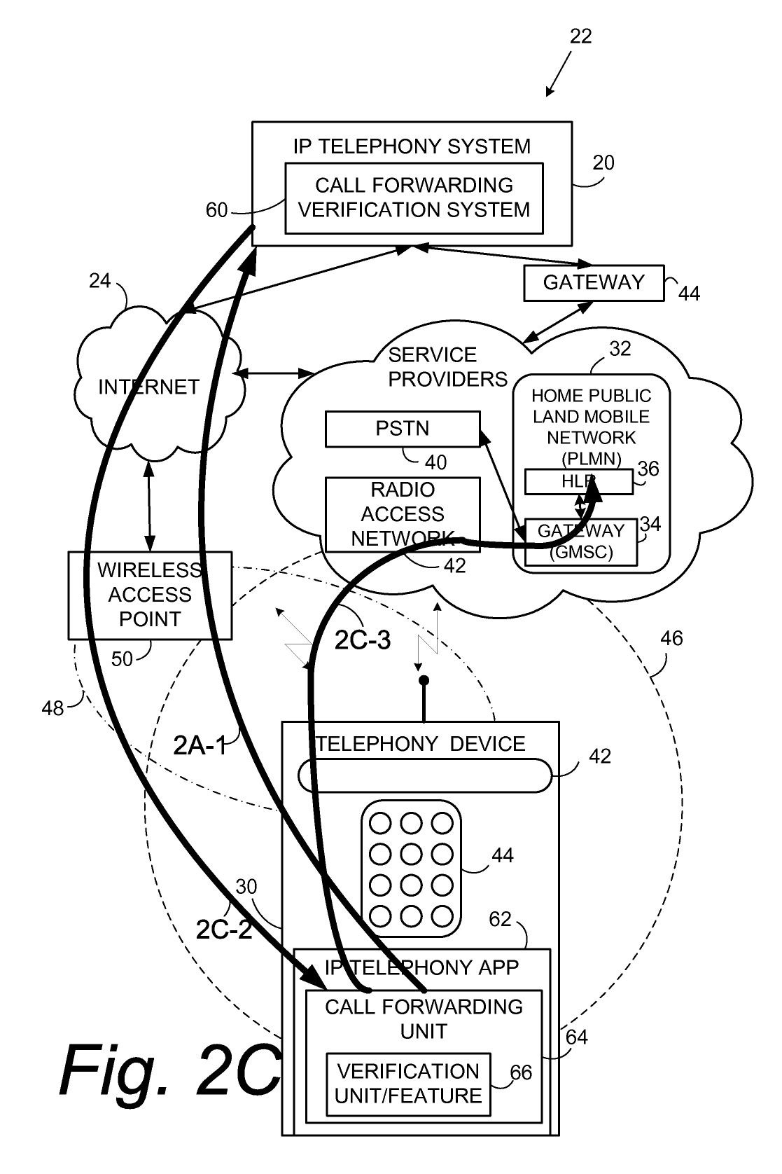

A call forwarding operation may be requested in various ways, as illustrated by exemplary scenarios of FIG. 2A, FIG. 2B, and FIG. 2C, as well as ways further described in U.S. Pat. No. 8,600,364, incorporated herein by reference.

In some such scenarios, illustrated in FIG. 2A, when wireless telephony device 30 is in the cell 48 of the wireless access network, the IP telephony application 62 may send a call forwarding request message 2A-1 through wireless access point 50 and Internet 24 to IP telephony system 20. The IP telephony application 62 is configured to include, in the notification such as call forwarding request message 2A-1, information that either prompts or enables, or both prompts and enables, the Internet telephony service 20 to perform a call forwarding verification operation. Such information may comprise, in an example embodiment and mode, at least one of a nominal telephone number associated with the wireless telephony device, an identifier associated with the wireless telephony device, and/or an account associated with the wireless telephony device. The nominal telephone number may be, for example, a directory number for the wireless telephony device 30 or any number of a format that specifies traditional telephone number information such as an area code (usually three digits), an exchange number (usually three digits), and a unique number within the exchange (usually four digits), for example. The identifier may be any other way of characterizing or addressing the telephony device 30, preferably uniquely, and may comprise a string of numbers or letters or other symbols.

In at least some exemplary embodiments and modes the call forwarding request message 2A-1 includes a call forwarding number to be used for the wireless telephony device 30. In other exemplary embodiments and modes the call forwarding number for wireless telephony device 30 may be pre-known or pre-stored at IP telephony system 20.

The IP telephony system 20 may then attempt to direct the home carrier 32 to implement the call forwarding operation, as reflected by call forwarding request message 2A-2. In the illustration of FIG. 2A the call forwarding request message 2A-2 results in the home carrier 32 successfully implementing the call forwarding request. As a result, the home carrier 32 will store in its PLMN home location register (HLR) 36 an indication that any incoming communication associated with an identifier for wireless telephony device 30 will now be directed to a forwarding number. As mentioned above, the forwarding number may be included in the call forwarding request message 2A-1 or pre-known by IP telephony system 20, and is included in call forwarding request message 2A-2. Preferably in an exemplary embodiment the forwarding number is a number associated with the IP telephony system 20. Thereafter, whenever the home carrier 32 receives an incoming communication with the identifier associated with wireless telephony device 30, the home carrier 32 consults the PLMN home location register (HLR) 36, obtains the forwarding number, and forwards the incoming communication to IP telephony system 20 so that IP telephony system 20 routes the incoming communication through Internet 24 to wireless access point 50 and thus ultimately to wireless telephony device 30, rather than through radio access network(s) (RANs) 42, for example. The identifier for wireless telephony device 30 may be, for example, a nominal telephone number (e.g., a directory or prior telephone number for wireless telephony device 30).

In the scenarios of FIG. 2A, the IP telephony application 62 may send the call forwarding request message 2A-1 in any of several scenario cases. A first such case is that the IP telephony application 62 remains active as wireless telephony device roams into and out of coverage of wireless telephony device 30 and/or other comparable wireless access points; the activated IP telephony application 62 senses when wireless telephony device 30 roams into the cell 48 of the wireless access network of wireless access point 50; and, upon sensing/detecting coverage in the cell 48 of wireless access point 50, the IP telephony application 62 automatically (without user input) sends the forwarding request message 2A-1. That is, the call forwarding verification system 60 is configured to send a request for the call forwarding operation upon detection of service of the wireless access network.

A second such case is one in which the customer or user of wireless telephony device 30 ascertains or believes that the wireless telephony device 30 is in coverage of the cell 48, and turns on the IP telephony application 62. When the IP telephony application 62 senses the coverage of cell 48, without further user input the IP telephony application 62 sends the forwarding request message 2A-1.

A third such case is one in which the IP telephony application 62 waits for explicit user input, e.g., via interface 42 or interface 44, before sending the forwarding request message 2A-1.

In other scenarios, illustrated in FIG. 2B, when wireless telephony device 30 is in the cell 48 of the wireless access network, the call IP telephony application 62 may not need to send an explicit message requesting a call forwarding operation. Rather, when call IP telephony application 62 establishes access or communication with IP telephony system 20 (as reflected by arrow 2B-1), the IP telephony system 20 may on its own initiative (or as pre-approved by the customer) request the call forwarding operation. That is, upon detection of communication with wireless telephony device 30 the IP telephony system 20 may send the call forwarding request message 2A-2 to the home carrier 32 for wireless telephony device 30.

In the call forwarding request scenario of FIG. 2C the IP telephony system is unable or unsuccessful in requesting the call forwarding operation. The acts of the call forwarding request scenario of FIG. 2C can follow either the scenario of FIG. 2A or the scenario of FIG. 2B. But in the scenario of FIG. 2C call forwarding request message 2A-2 is not generated by IP telephony system 20 for any of a variety of reasons. One such reason is that there may be network errors, such as a carrier changing its implementation such that queries from the internet-based telephony system 20 (such as Mobile Application Part [MAP] queries) do not work anymore and/or there are other technical incompatibilities. Instead, upon realizing its inability to request the call forwarding operation, IP telephony system 20 generates a call forwarding delegation message 2C-2 which is sent back through Internet 24 to wireless access point 50, and thus to wireless telephony device 30. The call forwarding delegation message 2C-2 requests and authorizes wireless telephony device 30 to makes the call forwarding request without further involvement of IP telephony system 20, e.g., for the wireless telephony device 30 to make the call forwarding request through radio access network(s) (RANs) 42 to home carrier 32. The call forwarding delegation message 2C-2 may include information that may be passed in the background from wireless telephony device 30 to home carrier 32 in an application programmable interface (API) call. Thus the call forwarding verification system 60 of IP telephony system 20 is configured in the case of FIG. 2C to request the wireless telephony device 30 to request that a native home carrier, e.g., home carrier 32, implement the call forwarding operation. In view of the foregoing, FIG. 2C shows call forwarding unit 64, upon receipt of call forwarding delegation message 2C-2, sending a call forwarding request 2C-3 through radio access network(s) (RANs) 42 to home carrier 32. The call forwarding request 2C-3 may be a standardized application programmable interface (API) call and as such may include a special code or format to turn on call forwarding, such as “#21*xxx*(wherein “xxx” is the call forwarding number to be used upon implementation of the call forwarding operation). Hopefully in response to call forwarding request 2C-3 the PLMN home location register (HLR) 36 implements the call forwarding request by pointing to and causing use of the call forwarding number for a subsequent incoming communication to wireless telephony device 30.

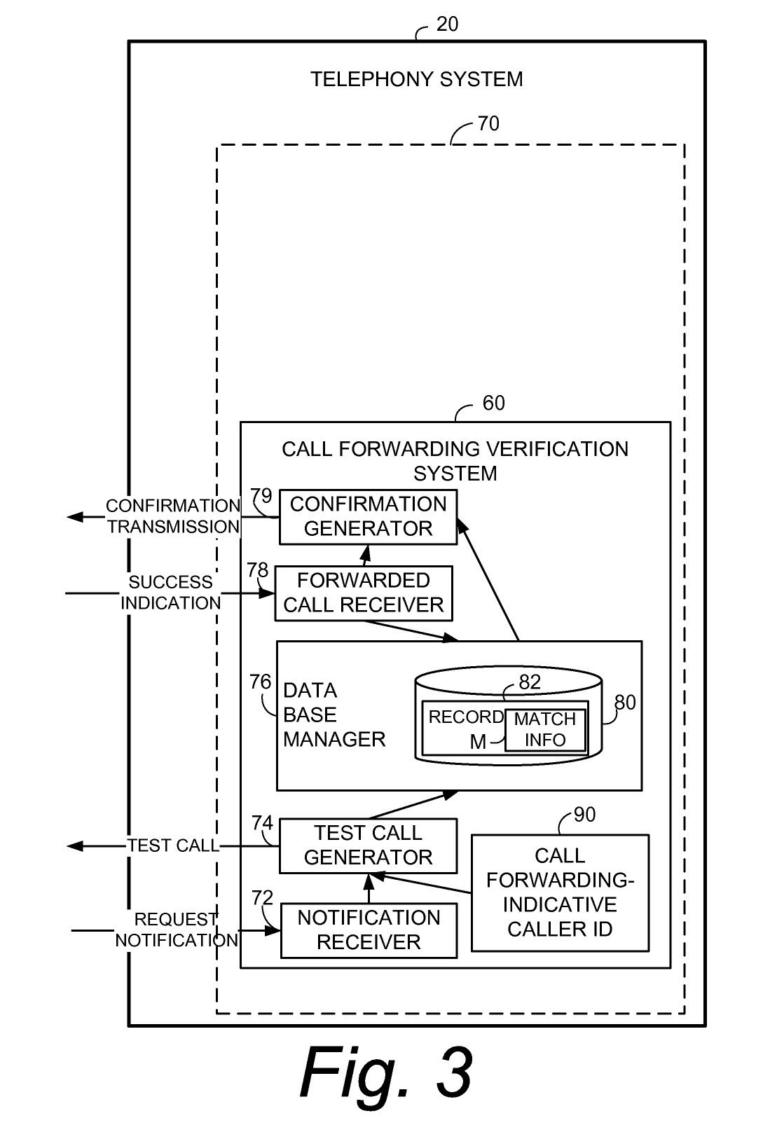

The technology disclosed herein provides, e.g., confirmation or verification of implementation of the call forwarding operation. The confirmation or verification obtained by the technology disclosed herein may follow call forwarding requests attempted in any prior art scenario, whether by the scenarios of FIG. 2A, FIG. 2B, or FIG. 2C, or otherwise. As one aspect of the technology disclosed herein, IP telephony system 20 comprises call forwarding verification system 60 which initiates a test call to a wireless telephony device in conjunction with a request for a call forwarding operation. As explained herein, the request for the call forwarding operation is configured to instruct that a subsequent call to the wireless telephony device be directed to a forwarding number. In an exemplary embodiment, the test call may be based on an identifier associated with wireless telephony device 30. In an exemplary embodiment the identifier comprises or otherwise indicates a nominal telephone number for wireless telephony device 30, or any other descriptor (usually comprising a string of numbers and/or letters) that may used for addressing or characterizing the telephony device 30. FIG. 3 illustrates example functionalities and or units which, in a non-limiting exemplary embodiment, comprise call forwarding verification system 60. In an exemplary embodiment, call forwarding verification system 60 may be implemented by machine hardware 70, as discussed herein. One non-limiting exemplary implementation of machine hardware 70 is a computer implementation in which, e.g., the call forwarding verification system 60 is implemented using one or more processors.

FIG. 3 shows call forwarding verification system 60 as comprising notification receiver 72; test call generator 74; data base manager 76; forwarded call receiver 78; and success confirmation generator 79. The data base manager 76 manages test call database 80. FIG. 3 further shows one example test call record 82, a record for a test call made for wireless telephony device 30, being stored in test call database 80. It will be appreciated that other test call records may be stored in test call database 80 for other wireless telephony devices.

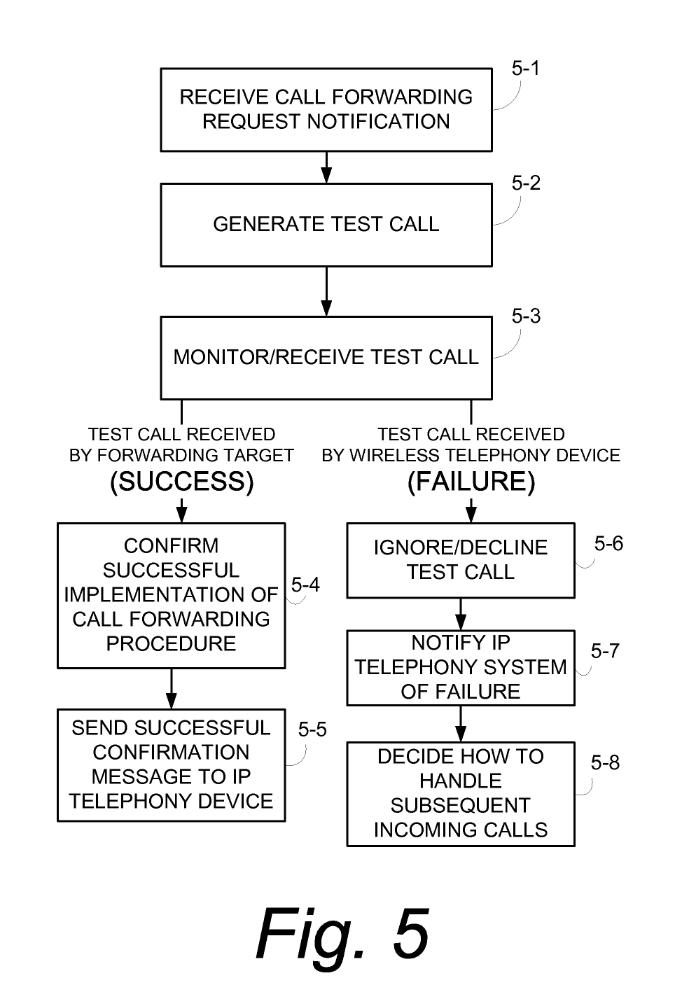

Operations and interactions of the exemplary functionalities and or units of call forwarding verification system 60 are understood with reference to actions such as, for example, those of FIG. 5 as described below.

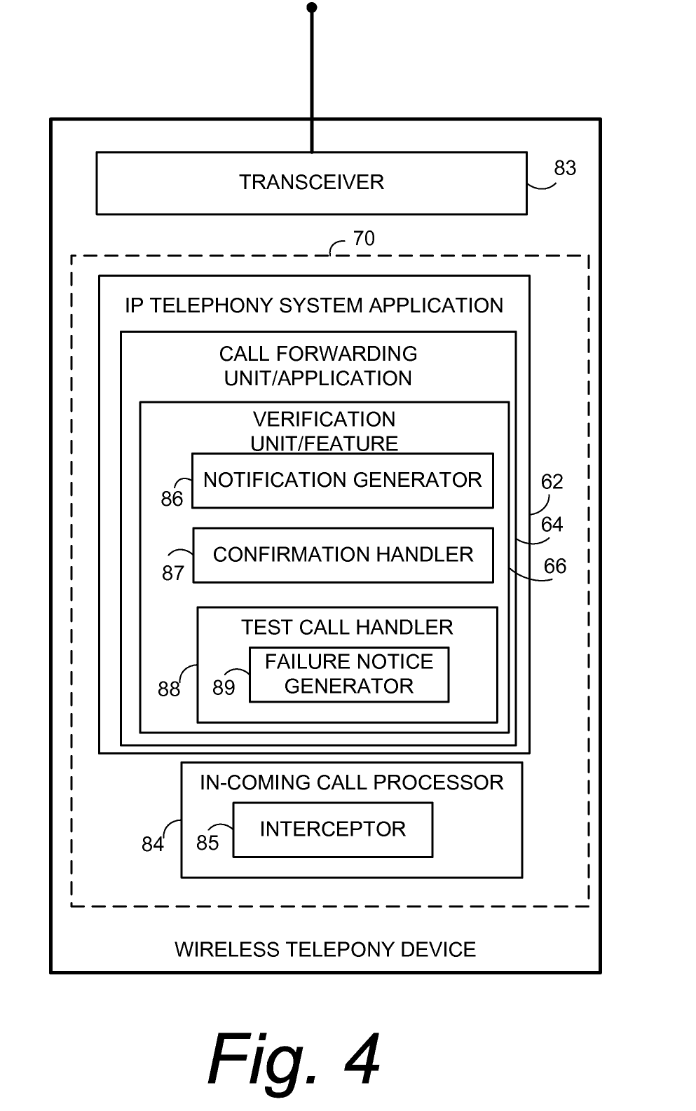

FIG. 4 shows example, non-limiting functionalities and/or units of a wireless telephony device 30 according to an exemplary embodiment. The example wireless telephony device 30 comprises one or more transceivers 83, which may communicate wirelessly (e.g., across a radio or air interface) to send and receive communications. Using differing communication resources and by virtue of one or more antenna, the transceiver 83 may communicate with radio access network(s) (RANs) 42, typically over licensed frequencies and typically with wireless access point 50 over unlicensed frequencies.

As previously mentioned, wireless telephony device 30 comprises IP telephony application 62, which in turn comprises call forwarding unit 64, which in turn comprises call forwarding verification unit 66. In addition, wireless telephony device 30 comprises in-coming call processor 84 which, like call IP telephony application 62, may be comprised of or executed on machine hardware 70. The in-coming call processor 84 comprises incoming call interceptor 85.

As further shown in FIG. 4, call forwarding verification unit 66 of wireless telephony device 30 comprises notification generator 86; confirmation handler 87; and test call handler 88. The test call handler 88 in turn comprises failure notice generator 89.

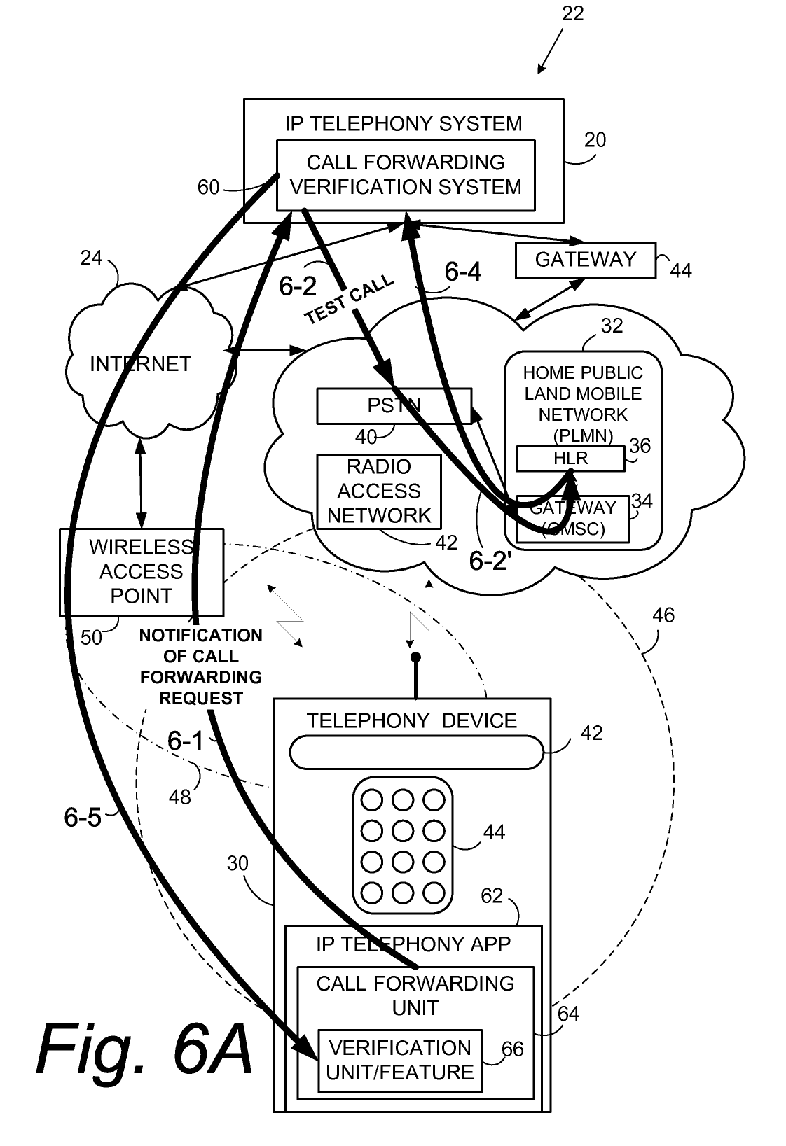

FIG. 5 in conjunction with FIG. 6A and FIG. 6B illustrates basic example acts or steps comprising a call forwarding verification operation performed in accordance with the technology disclosed herein. Act 5-1 of FIG. 5 and arrow 6-1 of FIG. 6A and FIG. 6B comprises or illustrates call forwarding verification system 60 receiving a notification that the call forwarding operation is being requested. Such notification may be received by notification receiver 72 of FIG. 3. The notification may comprise, for example, the call forwarding request message 2A-1 described above (in which case the notification that the call forwarding operation is an actual request for the call forwarding operation). Even in a situation, such as that of FIG. 2C, in which the call forwarding request message 2A-1 does not result in implementation of the call forwarding operation, such call forwarding request message 2A-1 may serve as notification that the call forwarding operation will be requested in other ways, such as by the call forwarding request 2C-3 which is sent from IP telephony application 62 to home carrier 32 in the manner described above. For example, after sending the call forwarding delegation message 2C-2 back to wireless telephony device 30, the IP telephony system 20 may presume that, after a predetermined wait period, the call forwarding operation has been implemented as a result of the call forwarding request 2C-3 sent by wireless telephony device 30 to home carrier 32.

The notification of act 5-1 (that call forwarding has been requested) may comprise an identifier of the wireless telephony device 30 or account associated with wireless telephony device 30. Such identifier may be an account name, a device ID (e.g., media access control [MAC] address), an application identifier (e.g., an identifier for a specific installation of an application on a specific device), or a telephone number (e.g., nominal telephone number) of the wireless telephony device 30, for example. In at least some exemplary embodiments and modes the notification of act 5-1 includes a call forwarding number to be used for the wireless telephony device 30. In other exemplary embodiments and modes the call forwarding number for wireless telephony device 30 may be pre-known or pre-stored at IP telephony system 20.

The notification of act 5-1 may be optional in some example embodiments and modes, such as the example scenario of FIG. 2C in which the IP telephony system proceeds to implement act 5-2 (described below) without an explicit notification from wireless telephony device 30. Viewed alternatively, merely establishing communications with IP telephony system 20, e.g., access to IP telephony system 20, may be considered (e.g., by IP telephony system 20) as a request for a call forwarding operation.

Act 5-2 of FIG. 5 comprises call forwarding verification system 60 generating a test call to the identifier associated with the wireless telephony device 30. In an example embodiment and mode the test call may be generated by test call generator 74. The test call is thus originated from IP telephony system 20 and preferably bears an identifier associated with a call forwarding attempt. The test call is also depicted by arrow 6-2 in FIG. 6A and FIG. 6B. The test call of act 5-2 is routed through the service providers to the switching center (GMSC) 34 of the home carrier for wireless telephony device 30 as depicted by arrow 6-2′ in FIG. 6A and FIG. 6B. As understood herein, a test “call” may be any type of communication, e.g., a telephone communication, a video communication, a text and/or video communication, and other forms of telephony and data communications. The fact and timing of generation of the test call is stored in a test call record 82 for wireless telephony device 30 maintained in test call database 80. Storage, retrieval, and operation upon such test call record 82 are governed by data base manager 76.

In an example embodiment and mode, the test call generated as act 5-2 may include a call forwarding-indicative caller ID. In some embodiments, the test call may carry a predetermined identifier which will enable call forwarding verification system 60 to recognize an incoming call as being a test call which the call forwarding verification system 60 itself generated. The capability of including or using such a call forwarding-indicative caller ID is reflected by call forwarding-indicative caller ID logic 90 in the example embodiment of FIG. 3

Act 5-3 comprises call forwarding verification system 60 monitoring for receipt of an indication that the test call test call which was generated at act 5-2 was successfully directed to the forwarding number. In some example embodiments and modes the forwarding number is preferably a number associated with a server or the like of IP telephony system 20. In other example embodiments and modes the forwarding number may be associated with a target other than IP telephony system 20.

Further acts of FIG. 5 depend on how the test call was received: whether the test call was received by the intended target (e.g., IP telephony system 20) or by wireless telephony device 30. The further acts and further arrows of FIG. 6A depict the situation in which the test call was received by the target (a successful call forwarding request); the further acts and further arrows of FIG. 6B depict the situation in which the test call was received by wireless telephony device 30 (a failed call forwarding request).

If the target of the test call is IP telephony system 20 and the test call is received by the IP telephony system 20, as shown by arrow 6-4 of FIG. 6A, the call forwarding verification system 60 may verify that the received call matches with the test call having test call record 82 stored in test call database 80. The test call may be received by forwarded call receiver 78 of IP telephony system 20, for example. If such a match is confirmed, then success of the call forwarding operation is also confirmed as indicated by act 5-4 of FIG. 5.

The basis of the match may include match information M which is both stored in the test call record 82 and carried in the test call. In an example embodiment and mode such match information may include a Mobile Subscriber Integrated Services Digital Network-Number (MSISDN) associated with the telephony device 30. The MSISDN may be viewed as the telephone number to the SIM card in a mobile/cellular phone. Inclusion of match information M such as MSISDN allows a matching of incoming received call to internet-based telephony system 20 with test call records when there are incoming test calls for multiple telephony devices or customers. Moreover, the match information M may also include a transaction identifier generated by internet-based telephony system 20 and associated with and/or included with a particular test call made at a particular time to a particular telephony device 30, to distinguish the test call with one or more other test calls that may have been made or may subsequently be made to the same telephony device 30. In an example embodiment and mode the match information M may be included as part of a header of the test call, e.g., proprietary field of the header such as a Session Description Protocol (SDP) field, for example).

An indication of success of the call forwarding operation may also be provided to wireless telephony device 30 by an optional message as depicted by act 5-5 of FIG. 5 and arrow 6-5 of FIG. 6A. Such message may be generated by success confirmation generator 79 of FIG. 3. That is, upon receipt of an indication that the test call was successfully directed to the forwarding number, the call forwarding verification system 60 generates a transmission to the wireless telephony device 30 confirming implementation of the call forwarding operation. The message may take the form of an interactive voice response (IVR) welcome to the wireless telephony device 30. Thus, when the call forwarding operation has been implemented the wireless telephony device 30 may receive a confirmatory indication from the Internet telephony service 20 as depicted by act 5-5. For example, confirmation handler 87 may receive the confirmatory indication from the Internet telephony service 20.

As mentioned above, in some embodiments and modes the target of the test call is other than IP telephony system 20. In such embodiments and modes there are several techniques for detecting that the test call has reached its target, e.g., that the test call is successful. One such technique is to time the test call for short duration, e.g., two seconds, so that if received it would be received by the forwarding number but not by the wireless telephony device 30. Another technique is to configure the test call to play an interactive voice response (IVR) upon being answered. In accordance with this technique, if telephony device 30 receives the test call then the call forwarding operation was not successful. The IVR may provide the receiving party, whether the target or not, with certain options (e.g., “press 1 if you are the target”, “press 2 if you are wireless telephony device 30”) which may facilitate whether the target has been reached or not. Another technique is to obtain, from a call reporting system, an indication of whether the test call was successful or not. The call processing network and the call forwarding verification system 60 send events to the call reporting system, so that the call reporting system may analyze how and where events, including the test call, are received.

On the other hand, if the test call is received by wireless telephony device instead of IP telephony system 20 (as shown by arrow 6-6 in FIG. 6B), the call forwarding operation has not been successfully implemented, e.g., the call forwarding operation has failed. In the event of such call forwarding operation failure, as act 5-6 the call forwarding verification unit 66 of the IP telephony application 62 of wireless telephony device 30 does not accept, e.g., declines, the test call placed to it (which should, instead, had been routed to IP telephony system 20 if the call forwarding operation had been successful). In an example embodiment, the test call handler 88 of the IP telephony application 62 of wireless telephony device 30 does not accept the test call. There are several ways in which the call forwarding verification unit 66 may realize that the call it has received is a test call originated by IP telephony system 20. One way to recognize a test call is to check a caller identifier (“caller ID”, see forwarding-indicative caller ID logic 90 of FIG. 5) associated with the test call. Alternatively, the test call may include a transaction identifier generated by internet-based telephony system 20 and associated with and/or included with a particular test call made at a particular time to a particular telephony device 30, and the telephony device 30 may recognize the transaction identifier (e.g., as belong to a range of values that internet-based telephony system 20 may use for generating test calls). In an example embodiment and mode the transaction identifier may be included as part of a header of the test call, e.g., proprietary field of the header such as a Session Description Protocol (SDP) field, for example).

As act 5-7 and as illustrated by arrow 6-7 in FIG. 6B, the call forwarding unit 64 (e.g., failure notice generator 89) notifies IP telephony system 20 that the call forwarding operation failed, e.g., that the test call was routed to wireless telephony device 30 rather than to wireless telephony device 30. Such failure result indication may be received by notification receiver 72, which in turns notifies (via test call generator 74) the data base manager 76 so that the test call record 82 pending for the test call may be deleted or otherwise marked as a failure. The call forwarding verification system 60 may have reason to suspect failure of the test call if the call forwarding verification system 60 does not receive the test call within a predetermined period of time, and therefore may on its own initiative adjust the test call record 82 accordingly.

Further, as act 5-8 the IP telephony application 62 of wireless telephony device 30 must decide, possibly on a call-by-call basis, how to handle further incoming communications which, in view of the call forwarding operation failure, are routed to wireless telephony device 30 through radio access network(s) (RANs) 42. In an example embodiment in-coming call processor 84 may make such decision(s). The operation system of some wireless telephony devices provide a mechanism (e.g., an application programmable interface (API)) to notify an application such as IP telephony application 62 of an incoming call, so that based on the telephone number or identifier or other information of the incoming call(er) the IP telephony application 62 may decide how to handle the incoming call. For example, some incoming communications may be designated by the IP telephony application 62 to be priority communications that should be accepted under any condition, or alternatively, under certain specified conditions. Other incoming communications may be “blacklisted” by the IP telephony application 62 so that such incoming communications are automatically declined. Such decisions as to how to handle an incoming, non-forwarded call may be performed by or in conjunction with incoming call interceptor 85. Act 5-7, e.g., notification of IP telephony system 20 of the call forwarding operation failure, may be performed in conjunction with act 5-8, e.g., the API that handles the incoming communications.

The incoming call interceptor 85 may be implemented by a program (e.g., call IP telephony application 62) running on wireless telephony device 30 and performing special instructions based on telephony level operation system events. One example event may be “call from X is now received”. Based on the value of “X” which may be a calling party number, the incoming call interceptor 85 may execute its logic as to how to handle the incoming call.

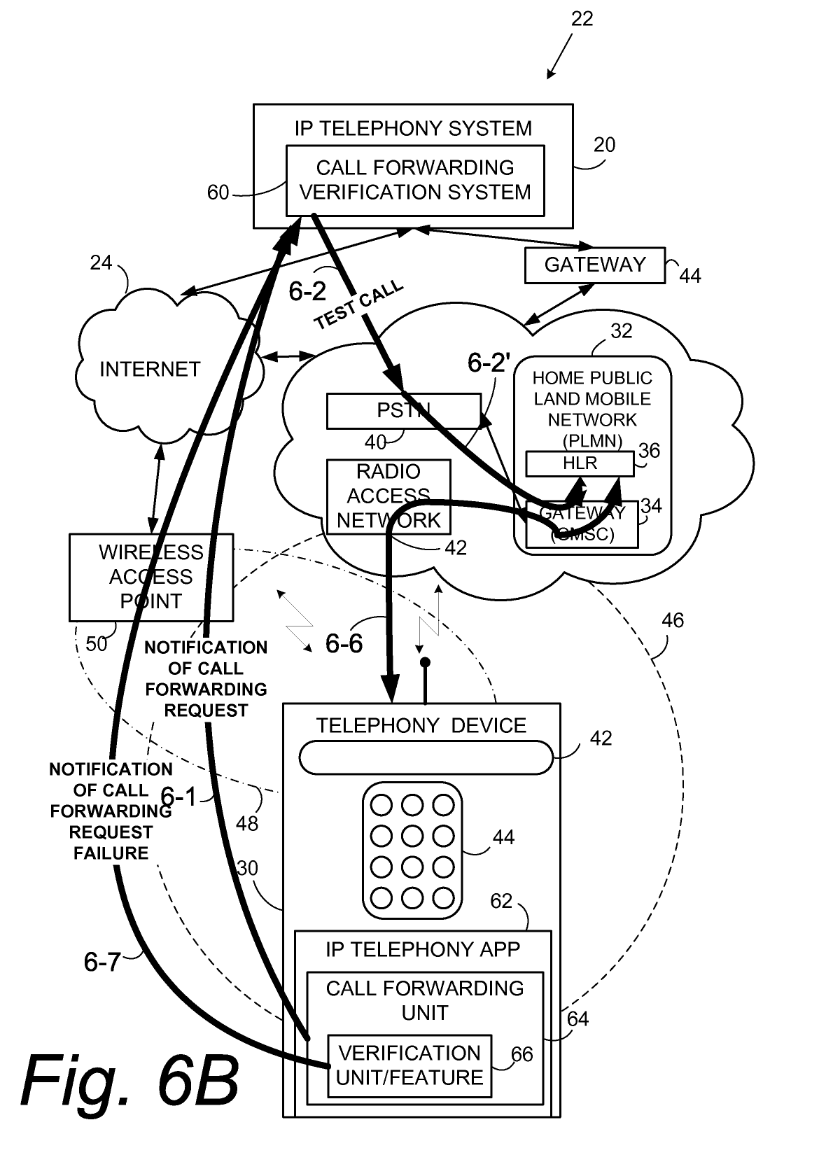

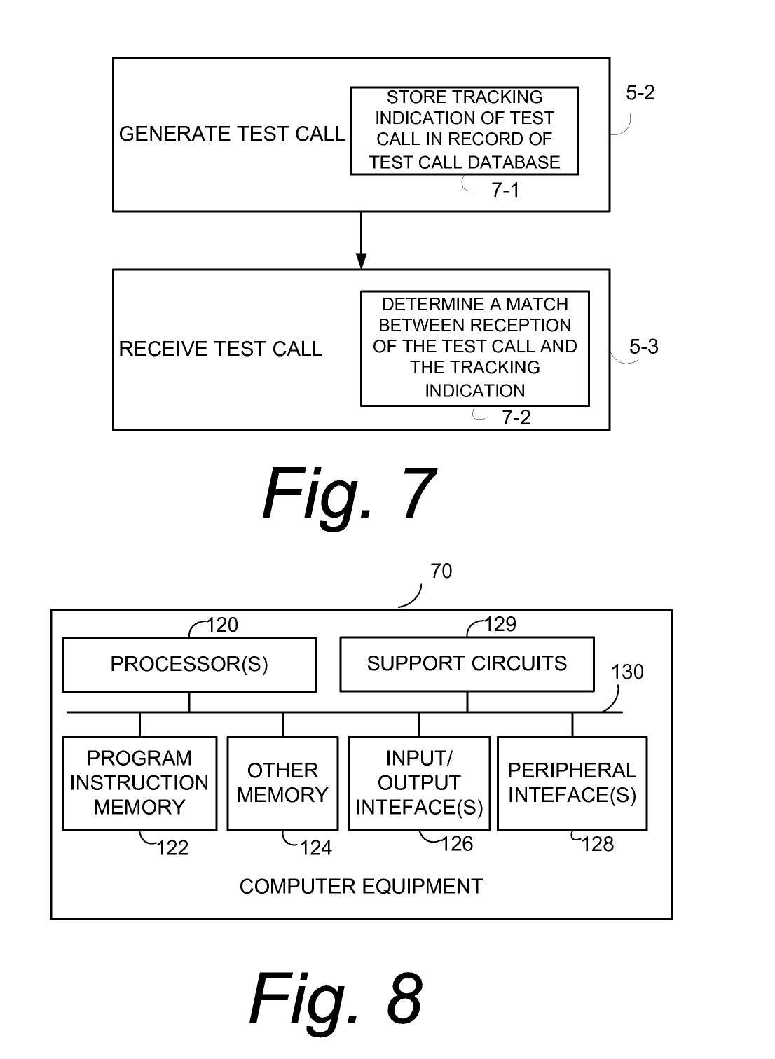

FIG. 7 shows example detailed acts or steps performed by call forwarding verification system 60 in an exemplary embodiment and mode. As mentioned above, act 5-1 of FIG. 5 comprises call forwarding verification system 60 generating a test call. In an exemplary mode and embodiment act 5-1 comprises initiating the test call to the wireless telephony device in a manner whereby the test call is routed to a home carrier network 32 that serves the wireless telephony device. FIG. 7 shows that the call forwarding verification system 60 may, in conjunction with generation of the test call, as act 7-1 cause storing of a tracking indication of initiation of the test call (to the wireless telephony device 30) in record 82 (which pertains to the wireless telephony device 30) of test call database 80. The test call may be associated in test call record 82 with an identifier associated with the wireless telephony device 30 or with the particular request for the call forwarding operation. Act 5-3 of FIG. 5 depicts receipt of the test call. When the test call is received by IP telephony system 20, as act 7-2 the call forwarding verification system 60 may determine a match between reception of the test call and the tracking indication stored in test call record 82 of test call database 80. Such match may be confirmed on the basis of the identifier associated with the wireless telephony device 30 or with the particular request for the call forwarding operation.

If a call forwarding operation is unsuccessful, the call forwarding verification system 60 may be configured to make one or more repeated attempts to implement the call forwarding operation. Such repeated attempts entails further test calls. In making repeated test calls the call forwarding verification system 60 may keep track of the test calls using test call database 80. For example, there may be a separate caller ID number or other parameter (e.g., match information M) associated with different test calls implemented successively for the same wireless telephony device 30. In an example implementation, successive test calls may be initiated after elapse of different time intervals. For example, a first test call may be placed after an elapse of 2 seconds; a second test call after an elapse of 10 seconds; a third test call after an elapse of 30 seconds. As another variation, if a first call forwarding attempt is not successful, the call forward verification system 60 may direct the home carrier 32 to implement the call forwarding operation to an alternate forwarding number. Preferably the alternate forwarding number also is a number of internet-based telephony system 20.

It was mentioned above that functions described herein, including the call forwarding verification system 60 of IP telephony system 20 and the call forwarding verification unit 66 of wireless telephony device 30 may, at least in some embodiments and modes, be performed by machine hardware 70. FIG. 8 shows an example of such machine hardware 70 as comprising one or more processors 120, program instruction memory 122; other memory 124 (e.g., RAM, cache, etc.); input/output interfaces 126; peripheral interfaces 128; support circuits 129; and busses 130 for communication between the aforementioned units.

The memory 124, or computer-readable medium, may be one or more of readily available memory such as random access memory (RAM), read only memory (ROM), floppy disk, hard disk, flash memory or any other form of digital storage, local or remote, and is preferably of non-volatile nature. The support circuits 129 are coupled to the processors 120 for supporting the processor in a conventional manner. These circuits include cache, power supplies, clock circuits, input/output circuitry and subsystems, and the like.

Software routines such as software for call forwarding verification system 60 of IP telephony system 20 and software for call forwarding verification unit 66 of wireless telephony device 30 may be computer program products which include coded instructions stored on non-transient medium and which are executed by processors 120 of the IP telephony system 20 and wireless telephony device 30, respectively, for performing the acts described herein. For the machine hardware 70 of each of IP telephony system 20 and wireless telephony device 30 such software/computer program products may be stored on non-transient memory such as program instruction memory 122. Also, the software routines could also be stored remotely from the CPU, e.g., remotely from processors 120. For example, the software could be resident on servers and memory devices that are located remotely from the CPU, but which are accessible to the CPU via a data network connection. Such software, when executed by processors 120, transforms the general purpose computer into a specific purpose computer that performs one or more functions of the IP telephony system 20. Although the processes of the disclosed embodiments may be discussed as being implemented as a software routine, some of the method steps that are disclosed therein may be performed in hardware as well as by a processor running software. As such, the embodiments may be implemented in software as executed upon a computer system, in hardware as an application specific integrated circuit or other type of hardware implementation, or a combination of software and hardware. The software routines of the disclosed embodiments are capable of being executed on any computer operating system, and is capable of being performed using any CPU architecture.

While the call forwarding verification has been described above in context of wireless telephony devices, it should be understood that the call forwarding verification technology described herein has broader applicability and indeed applies to wired, e.g., non-wireless telephony devices as well.

In the foregoing description the wireless telephony device 30 may send various communications, including notifications and requests or messages, to wireless telephony device 30 when in wireless contact with wireless access point 50. In some instances, should contact or communications with wireless access point 50 be lost, the wireless telephony device 30 may store the information which it will use for such communications in memory or file system locally and later send to IP telephony system after data communications/connection is established. The converse is also true for communications which IP telephony system 20 intends to send to wireless telephony device 30.

The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented, and thus machine-implemented.

In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) [ASIC], and/or field programmable gate array(s) (FPGA(s)), and (where appropriate) state machines capable of performing such functions.

In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” shall also be construed to refer to other hardware capable of performing such functions and/or executing software, such as the exemplary hardware recited above.

The technology disclosed herein has many advantages. One such advantage is reliable knowledge of success or failure of a call forwarding operation. Such knowledge may be obtained using the technology disclosed herein in a manner that is agnostic regarding a chipset or operating system employed by the wireless telephony device 30.

Although the description above contains many specificities, these should not be construed as limiting the scope of the technology disclosed herein but as merely providing illustrations of some of the presently preferred embodiments of the technology disclosed herein. Thus the scope of the technology disclosed herein should be determined by the appended claims and their legal equivalents. Therefore, it will be appreciated that the scope of the technology disclosed herein fully encompasses other embodiments which may become obvious to those skilled in the art, and that the scope of the technology disclosed herein is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the technology disclosed herein, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A telephony system comprising a computer-implemented call forwarding verification system configured to initiate a test call to a telephony device in conjunction with a request for a call forwarding operation, the request for the call forwarding operation being configured to instruct that a subsequent call to the telephony device be directed to a forwarding number.

2. The telephony system of claim 1, wherein the test call is based on an identifier associated with telephony device.

3. The telephony system of claim 1, wherein the computer-implemented call forwarding verification system is configured to monitor for receipt of an indication that the test call was successfully directed to the forwarding number.

4. The telephony system of claim 1, wherein the computer-implemented call forwarding verification system is configured to receive from the telephony device a notification that the call forwarding operation is being requested.

5. The telephony system of claim 1, wherein the computer-implemented call forwarding verification system is configured to request the telephony device to request that a native home carrier implement the call forwarding operation, and wherein the computer-implemented call forwarding verification system is configured to thereafter make the test call.

6. The telephony system of claim 1, wherein the notification that the call forwarding operation comprises a message from the telephony device configured to request the call forwarding operation.

7. The telephony system of claim 1, wherein the forwarding number is associated with the call forwarding verification system, and wherein the computer-implemented call forwarding verification system is further configured to:
store a tracking indication of initiation of the test call to the telephony device in a record pertaining to the telephony device in a verification system database;
upon receipt by the verification system of the test call, determine a match between reception of the test call and the tracking indication stored in the verification system database.

8. The telephony system of claim 1, wherein the computer-implemented call forwarding verification system is configured to associate the test call with an identifier associated with a call forwarding attempt.

9. The telephony system of claim 1, wherein the computer-implemented call forwarding verification system is configured, upon receipt of an indication that the test call was successfully directed to the forwarding number, to generate a transmission to the telephony device confirming implementation of the call forwarding operation.

10. A telephony device comprising a processor configured:
in conjunction with a request for a call forwarding operation, to send, to an Internet telephony service, a notification that the call forwarding operation is being requested, the request for the call forwarding operation being configured to instruct that a subsequent call to the telephony device be directed to a forwarding number; and thereafter
when the call forwarding operation has failed, to decline a test call that is received, the test call originating from the Internet telephony service as a result of the notification.

11. The telephony device according to claim 10, wherein the telephony device is a wireless telephony device comprising a transceiver configured to participate in wireless communications.

12. The telephony device according to claim 11, wherein the processor is further configured to send the request for the call forwarding operation upon detection of service of the wireless access network.

13. The telephony device according to claim 10, wherein the processor is further configured to send an identifier associated with the telephony device, wherein the test call is based on the identifier.

14. The telephony device according to claim 10, wherein the processor is further configured to send a failure notification to the Internet telephony service upon receipt by the telephony device of the test call.

15. The telephony device according to claim 10, wherein the processor is further configured, when the call forwarding operation has failed, to decide how to handle a call received through the radio access network other than the test call.

16. The telephony device according to claim 10, wherein the processor is further configured, when the call forwarding operation has been implemented, to receive a confirmatory indication from the Internet telephony service.

17. The telephony device according to claim 10, wherein the processor is further configured to send, as the notification to the Internet telephony network, a request for the call forwarding operation.

18. The telephony device according to claim 10, wherein the processor is configured to include, in the notification, information that prompts the Internet telephony service to perform a call forwarding verification operation.

19. The telephony device according to claim 10, wherein the processor is configured to include, in the notification, information that enables the Internet telephony service to perform a call forwarding verification operation.

20. The telephony device according to claim 19, wherein the information comprises at least one or more of a nominal telephone number associated with the telephony device, an identifier associated with the telephony device, or an account associated with the telephony device.

21. The telephony device according to claim 19, wherein the test call is originated from the Internet telephony service and bears an identifier associated with a call forwarding attempt.

22. A method in a communications network comprising:
an Internet telephony service initiating a test call based on an identifier associated with a telephony device in conjunction with a request for a call forwarding operation, the request for the call forwarding operation being configured to instruct that a subsequent call to the telephony device be directed to a forwarding number;
the Internet telephony service monitoring for receipt of an indication that the test call was successfully directed to the forwarding number.
